(19) United States
(12) Patent Application Publication
(10) Pub. No.: US 2025/0042022 A1
(43) Pub. Date: Feb. 6, 2025

(54) GRASP-POINT IDENTIFYING AND LABELING OF OBJECTS FOR ROBOT MANIPULATION

(71) Applicant: Intel Corporation, Santa Clara, CA (US)

(72) Inventors: Raymundo VAZQUEZ LUGO, Zapopan (MX); Julio Cesar ZAMORA ESQUIVEL, Sacramento, CA (US); Edgar MACIAS GARCIA, Zacapu (MX); Cornelius BUERKLE, Karlsruhe (DE)

(21) Appl. No.: 18/361,980

(22) Filed: Jul. 31, 2023

(51) Int. Cl. B25J 9/16; B25J 13/08; G06T 7/50; G06T 7/73; G06V 20/50; G06V 20/70

(52) U.S. Cl. CPC B25J 9/1612; B25J 9/1697; B25J 13/085; G06T 7/50; G06T 7/75; G06V 20/50; G06V 20/70; G06K 7/1413; G06T 2207/10028; G06T 2207/20081; G06T 2207/30196

(57) ABSTRACT

Disclosed herein are systems, devices, and methods for labelling images with grasp points and/or task-related information. The system may receive sensor data of an observed grasping of an object by a hand. The system may also determine, based on the sensor data of the observed grasping of the object, a manipulation point in relation to the object. The system may also create a data label for the object, wherein the data label indicates the manipulation point for the object. The system may also control a robot to grasp an item at a grasping point based on the manipulation point in the data label.

### TECHNICAL FIELD

The disclosure relates generally to identifying and labeling grasp-points on objects that may be manipulated by a robot.

### BACKGROUND

In robotics, a common task of a robot is to manipulate an object. A robot may use computer vision to detect an object, and then the robot determines how it may grasp the object to perform its task in relation to the object. This may involve the robot computing a grasping point or points that would be suitable for its end-effector (e.g., the type of hand or tool used by the robot to grasp and manipulate the object) for the given type of object and its current location and orientation in space, also taking into account the environment in which the robot and object are located and the type of grasp manipulator (e.g. articulated fingers, suckers, etc.). Typically, grasping points are computed using a three-dimensional computer aided design (3D CAD) model of the detected object, where the computation is an optimization algorithm that evaluates the kinematics of the robot with respect to the detected object and takes into account physical properties of the object, e.g., fragility, surface friction, center of gravity, etc. Such an algorithm may result in multiple solutions that may not represent the best solution for manipulating the object and/or that may damage the object or the environment. For example, using a drinking cup as an example, such an algorithm my determine to pinch the wall of the drinking cup by introducing one finger inside the cup and another finger outside the cup. While this may be a valid way of grasping the cup, it may not be suitable because it may contaminate the interior of the cup (e.g., the “finger” of the robot touches/contaminates the liquid inside the cup). This may be an unacceptable method of manipulating the cup, for example, where the task is to deliver a (clean) drink to a person. The solutions offered by a three-dimensional computer aided design and simulations to determine grasping points may be undesirable, inappropriate, and/or inefficient.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an exemplary labeling system that may generate a data training set for use by a label-based manipulation point determination tool;

FIG. 2 illustrates an example of a hand or manipulator pose determination system that a labeling system may utilize to determine the model of the hand or manipulator based on the sensor data/image data;

FIG. 3 depicts an exemplary schematic drawing of a device for labeling images with grasp points and/or task-related information; and

FIG. 4 depicts an exemplary schematic flow diagram of a method for labeling images with grasp points and/or task-related information.

### DESCRIPTION

The following detailed description refers to the accompanying drawings that show, by way of illustration, exemplary details and features.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc., where “[ . . . ]” means that such a series may continue to any higher number). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc., where “[ . . . ]” means that such a series may continue to any higher number).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

A “vehicle” may be understood to include any type of machinery that may be operated by software, including autonomous, partially autonomous, stationary, moving, or other objects or entities that utilize software as part of their operation. By way of example, a vehicle may be a driven object with a combustion engine, a reaction engine, an electrically driven object, a hybrid driven object, or a combination thereof. A vehicle may be or may include an automobile, a bus, a mini bus, a van, a truck, a mobile home, a vehicle trailer, a motorcycle, a bicycle, a tricycle, a train locomotive, a train wagon, a robot, a personal transporter, a boat, a ship, a submersible, a submarine, a drone, an aircraft, industrial machinery, autonomous or partially autonomous machinery, or a rocket, among others.

A “robot” may be understood to include any type of digitally controllable machine that is designed to perform a task or tasks. By way of example, a robot may be an autonomous mobile robot (AMR) that may move within an area (e.g., a manufacturing floor, an office building, a warehouse, etc.) to perform a task or tasks; or a robot may be understood as an automated machine with end-effectors, arms, tools, and/or sensors that may perform a task or tasks at a fixed location; or a combination thereof. A robot may be understood as an automated or partially automated vehicle such as an automobile, a bus, a mini bus, a van, a truck, a mobile home, a vehicle trailer, a motorcycle, a bicycle, a tricycle, a train locomotive, a train wagon, a robot, a personal transporter, a boat, a ship, a submersible, a submarine, a drone, an aircraft, industrial machinery, autonomous or partially autonomous machinery, or a rocket, among others.

As noted above, robots often perform tasks that require it to manipulate an object. Current methods for the robot to detect the object and determine how to best grasp it, however, may be time consuming and lead to a solution that is ineffective, damaging, or inappropriate for the task. Disclosed herein is a label-based manipulation point determination tool that may provide a way for the robot to more quickly and more accurately identify grasping points in a way that is effective, not damaging, and appropriate for the robot's current task, also potentially considering physical properties of an object, the environment in which the robot operates (also considering robot environment (e.g., mixed human-robot environments), sensitive environments related to ecology, fragility, damage potential, etc.), and the capabilities of the robot and its end manipulator/effector (e.g. lifting power, reach, type of end manipulator/effector, size and shape of objects able to grasp/manipulate, etc.). The label-based manipulation point determination tool may use an artificial intelligence (AI) algorithm (e.g., a neural network, a learning model, a deep-learning network, etc.) that may provide ideal grasping points for the current task. In a further step, the robot may utilize the identified grasping points for manipulating an object in accordance with a task.

The AI algorithm may utilize a training data set of object-based data that associates an object with its ideal grasping points (also referred to as manipulation points). However, no training data sets currently exist that provide such an association, and creating a clean, effective, trusted training set may be difficult and expensive. To overcome this problem, disclosed below is a tool, method, and apparatus for creating a training set of labeled object data that associates an object with its ideal or effective manipulation point(s) for the task. This may depend on the object and its physical and material properties, the type of grasp manipulator (e.g. fingers, suckers on an articulated robot arm) and the environment in which the robot operates (e.g. making sure there is sufficient free space for the robot, the robot arm, the type of grasp manipulator and the object to operate successfully in the environment to execute a task without damaging robot, object, or environment). The disclosed automated label generation tool may create a large-scale database for objects based on manual manipulations in their real environment, e.g., based on observations of items/objects as they are handled by humans or other robots that may be performing a task and may be manipulating the item/object in a similar manner to what the robot may be tasked for in terms of manipulating such items/objects.

The label-based manipulation point determination tool may, for example, utilize sensors placed around the check-out station at a grocery store to capture observations (e.g., sensor data such as images, motion data, force data, etc.) about the picking, scanning, and placing of items on a conveyor belt and from conveyor belt into a shopping cart or shopping bag. For example, multiple images may be collected (e.g., before scanning, during scanning, and after scanning) to observe how the item is grasped in a natural and effective way by the grocery store employee who scans each item at checkout. Manipulation points, manipulation movements, manipulation forces, manipulation trajectories, etc. may then be observed and the item labeled with this information and associated with the tasks of picking and placing (e.g., picking may have a different set of information labels as compared to placing). Thus, every time that an item is scanned by the barcode reader, multiple images may be collected and processed by a model to determine the store employee's hand poses and associated grasping points required to grasp, manipulate, and release the product. This may be repeated for multiple items, multiple check-out stations, and over multiple days in order to automatically generate thousands of labeled samples by running the solution in parallel, while accounting for different light conditions, different camera perspectives, different items, different hand types, grasp poses, and environments.

Another example is that sensors may be placed around a packaging facility (e.g., at a warehouse where orders are fulfilled), where a human may locate item(s) in the warehouse and collecting and packaging them for transport to the customer. The sensors may observe the human-based collecting and packaging of the products. Based on the sensor data, manipulation points, manipulation movements, manipulation forces, manipulation trajectories, etc. may be determined and the item labeled with this information and associated with the tasks of collecting and packaging.

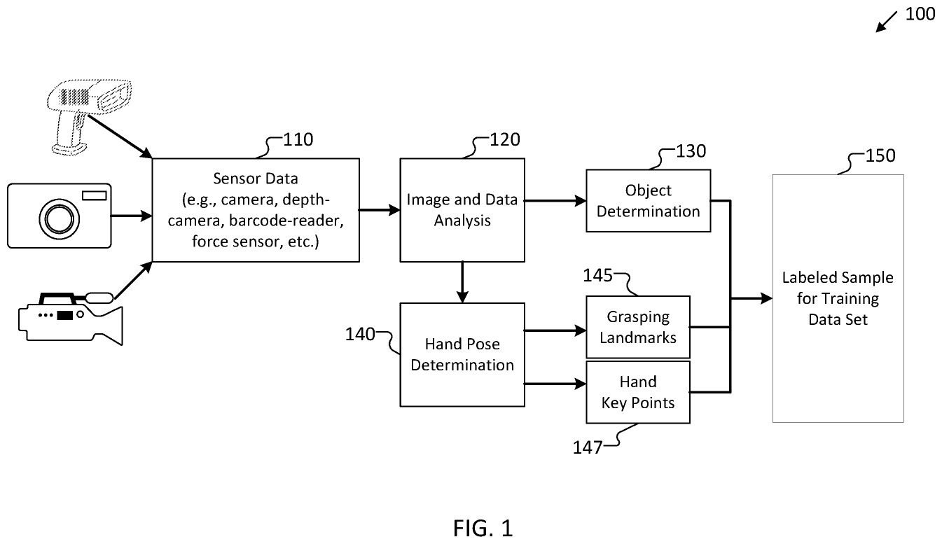

FIG. 1 shows a labeling system 100 that may generate a data training set for use by a label-based manipulation point determination tool that may provide a way for the robot to more quickly and more accurately identify grasping points in a way that is natural and appropriate for the robot's current task. Labeling system 100 may utilize any number of sensors, such a barcode reader, a camera, a depth camera, a red-green-blue (RGB) camera, a force sensor, etc., to collect sensor data 110 about items/objects. The sensor data 110 may include, for example, a series of images of the items/objects and associated sensor data (item identifiers, grasping forces, movement information, etc.) as they are being grasped by a human hand during the course of a task involving the object. For example, the series of images may show the item/object at different points in time throughout the course of the task. For example, where the task is to pick up an object from a conveyor belt, scan it, and place it on another conveyor belt (such as when checking-out items at a grocery store), the labeling system 100 may capture sensor data at a time when each item is being grasped by the checker, as it is being carried over the barcode scanner, and as it is being placed on the other conveyor belt. Using this set of sensor data, the labeling system 100 may perform image and data analysis 120 on the set of data to identify the object, differentiate the data associated with the object from the data associated with the hand that is grasping the object. For example, the labeling system 100 may, in object determination 130, determine the type of object based on the barcode data about the object as it was scanned with the barcode reader (e.g., a barcode on the object may be read by the barcode reader, where the barcode is associated with a unique identifier for the type of object (e.g., a product number of an item in a grocery store)). As should be understood, the object determination 130 may use other methods to identify the object such as through an object recognition algorithm.

Labeling system may, in hand pose determination 140, determine a model of how the hand is grasping the object. For example, hand pose determination 140 may generate a stick model of the pose of the hand that represents the palm, fingers, and finger tips of the hand in a two-dimensional or three-dimensional model that may include the size of the palm, the lengths of each segment of each finger, the angle of each segment of each finger relative to one another, etc. Based on the stick model with respect to the object, the labeling system 100 may determine the grasping landmarks 145 on the object and the hand key points 147 used to grasp the object (e.g., determining the way in which the object is handled by the human, e.g., determining that the tips of the thumb and forefinger are used to grasp a rim of the drinking glass object; determining the palm is cupped around a base of a round object; determining that all five fingers surround an object at equidistant key points of the fingers; etc.). Once the labeling system 100 has determined the grasping landmarks 145 and/or the hand key points 147, labeling system 100 combines this information with the object identifier (e.g., from object determination 130) for storing a labeled sample 150 (e.g., in a database/table that relates, for the image, an object identifier to its grasping points and associated information for how the object is grasped) in a training data set. For example, the stored information may include a triplet of information (e.g., an image, an object identifier, and a hand pose) stored as a labeled sample. This training data set may then be used by a learning model that relates objects to their preferred grasping points, where a robot may use the learning model to determine how to grasp an object. As should be understood, the labeled sample 150 may include task information for the type of task or tasks with which the determined grasp points. In this manner, the object identifier and grasp points may be associated with a task such that, depending on the task, different preferred grasp points may be stored for the object for each different task. In this manner, the data set may store grasp points for the object that are a natural way of grasping the object (e.g., human-like) for the given task.

As should be understood, labeling system 100 may operate continuously to continuously capture, analyze the image to determine hand poses/grasp points, and each label image accordingly. The labeling system 100 may then be set up near a human engaged in an object-manipulating task to continuously monitor the human as it manipulates objects during the task, such as a checker at a grocery store or a packager at a warehouse facility, in order to label numerous images with corresponding grasp point data for each task. In the checker example, every time that a product is scanned by the checker at the barcode reader, labeling system 100 may collect multiple images that may be processed by labeling system 100 to be stored and labeled as a sample labeled with the hand poses required to grasp, manipulate, and release the product. As the labeling process is automated, labeling system 100 may generate thousands of labeled samples in different light conditions, with different camera perspectives, for products, and with different hand types.

Labeling system 100 may segment the area of interest from the rest of scene in an image (or other sensor data). For example, a depth camera may be used to collect depth images of a scene containing the object being grasped by a hand, and the area of interest (i.e., the grasped object) may be isolated/segmented from the rest of the scene. This permits the labeling system 100 to obtain additional information related to the grasping type and the object's physical properties.

With respect to the ability of the labeling system 100 to determine grasping points, there may be any number of different ways a hand may grasp an object, depending on the task, which may lead to different grasping points for different tasks. As noted above, by observing the manipulation of the object by an actual human, the labeling system 100 is able to label images with natural grasp points as compared to artificial ones determined from a standard inverse kinematics algorithm. As noted above, there may be several different ways to grasp an object depending on the intention (e.g., the task associated with the manipulation/grasping of the object). In the checker example discussed above, for example, the manipulation employed in the checkout station may be appropriate for use by a robot who will also be picking, moving, and/or placing the object.

Using a coffee mug as an example, a human might manipulate a coffee mug in a number of different ways, including, for example, by using the handle of the mug to take a drink of coffee from the mug. In a different type of environment or for a different task, this type of grasp may be an inappropriate/inefficient grasp technique for training for a robot to pick/place a coffee mug from an assembly line into a package. As another example, a coffee mug may be grasped with multiple fingers around the top opening of the mug. With such a grasp, the handle and its position are not necessarily important to handling the mug in this manner. As a third example of the type of grasp, the coffee mug may be handled by inserting one or more fingers inside the opening of the mug and grasping the mug by exerting pressure between the thumb and fingers against the wall of the opening of the mug. Each of these methods of grasping may be associated with the particular task, and labeling system 100 may record these different grasping methods for the particular task so that a robot, for example, may be trained using the labels appropriate for the corresponding task of the robot.

Using a wine glass as an example, a human might manipulate the wine glass in different ways depending on the purpose or task associated with the manipulation. For example, if drinking out of the glass, the human may grasp the wine glass by the stem to delicately lift the glass to the lips. In an industrial environment, where the task is to remove the glass from a conveyor belt, a stem-based grasp may be inappropriate/inefficient. As another type of grasp, the wine glass may be grasped with multiple fingers around the top opening of the glass. With such a grasp, the delicate stem need not be located/handled. As a third example of a different type of grasp, the wine glass may be handled by inserting one or more fingers inside the opening of the glass and grasping the glass by exerting pressure between the thumb and fingers against the wall of the opening of the glass. Each of these methods of grasping the glass may be associated with the particular task, and labeling system 100 may record these different grasping methods for the particular task so that a robot, for example, may be trained using the labels appropriate for the corresponding task of the robot.

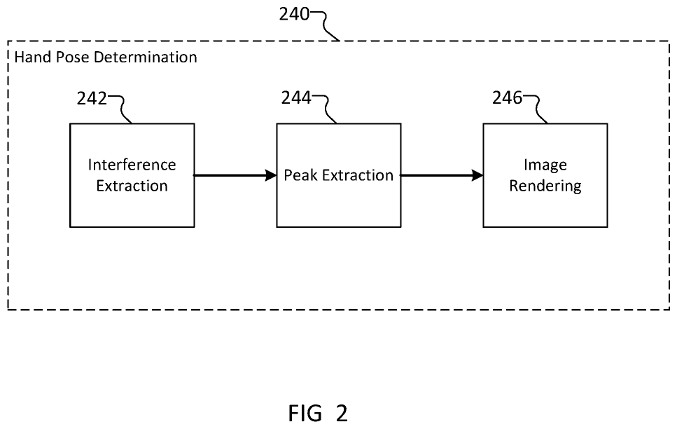

FIG. 2 shows an example of a hand pose determination system 240 that a labeling system may utilize (e.g., hand pose determination 140 of the labeling system 100 of FIG. 1) to determine the model of the hand based on the sensor data/image data. After the image has been captured, the image may be converted to an RGB format and normalized for consumption by a neural network model. For example, hand pose determination system 240 may, at 242, perform interference extraction to generate a heat map array. Next, at 244, hand pose determination system 240 may extract the peaks from the heat map array. Finally, the hand pose determination system 240 may determine, in 246, key points of the hands. Methods such as FreiHAND and ShallowUNet may be used by the hand pose determination system 240 to estimate the hand pose and determine key points. In some examples, hand pose determination system 240 may determine twenty-one key points as the set of key points representing the pose of the hand. As should be appreciated the number of key points may be smaller or larger, may be two dimensional or three dimensional, etc., depending on the desired precision, available storage space, and available computational power. As should be appreciated, hand pose determination system 240 may use deformable fractional filters to reduce the number of parameters while maintaining the accuracy of the model.

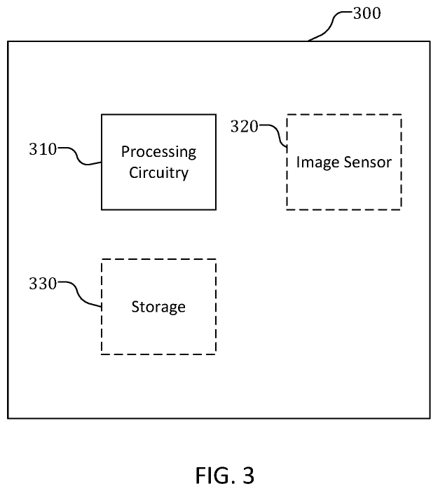

FIG. 3 is a schematic drawing illustrating a device 300 for labeling images with grasp points and/or task-related information. The device 300 may include any of the features of the labeling system discussed above (e.g., labeling system 100). FIG. 3 may be implemented as a device, a system, a method, and/or a computer readable medium that, when executed, performs the features of the labeling system discussed above. It should be understood that device 300 is only an example, and other configurations may be possible that include, for example, different components or additional components.

Device 300 includes processing circuitry 310 coupled to storage 330. Processing circuitry 310 of device 300 is configured to receive sensor data of an observed grasping of an object by a hand. Processing circuitry 310 is also configured to determine, based on the sensor data of observed grasping of the object, a (e.g., at least one) manipulation point in relation to (e.g., on) the object. Processing circuitry 310 is also configured to create a data label for the object, wherein the data label indicates the manipulation point for the object. Furthermore, in addition to or in combination with any of the features described in this or the following paragraphs, the processing circuitry 310 may be further configured to control a robot to grasp an item at a grasping point based on the manipulation point in the data label. Furthermore, in addition to or in combination with any of the features described in this or the following paragraphs, the processing circuitry 310 may be further configured to determine a grasping point for a robot to grasp an item based on the manipulation point in the data label.

Furthermore, in addition to or in combination with any of the features described in this or the previous paragraph with respect to device 300, the processing circuitry 310 may be further configured to store the data label in a memory (e.g., as part of storage 330) that associates data labels with object identifiers, wherein the data label and an identifier for the object may include a record in a database of the memory. Furthermore, in addition to or in combination with any of the features described in this or the previous paragraph with respect to device 300, the processing circuitry 310 may be configured to identify the object based on a barcode label on the object that provides a unique identifier for the object. Furthermore, in addition to or in combination with any of the features described in this or the previous paragraph, the processing circuitry 310 may be configured to determine the observed grasping of the object by the hand based on the sensor data, wherein the processing circuitry 310 may be further configured to segregate the hand from the object based on the sensor data and determine a pose of the hand with respect to the object. Furthermore, in addition to or in combination with any of the features described in this or the previous paragraph, the sensor data may include an image of the object and the hand, wherein the processing circuitry 310 may be configured to determine the pose of the hand based on an interference extraction on the image, a peak extraction from the image, and a rendering, based on the image, of a set of key points that define a multidimensional stick model of the pose. Furthermore, in addition to or in combination with any of the features described in this or the previous paragraph, the set of key points may include multiple points that together define the multidimensional stick model. Furthermore, in addition to or in combination with any of the features described in this or the previous paragraph, wherein the multiple points may include twenty-one points that together define the multidimensional stick model.

Furthermore, in addition to or in combination with any of the features described in this or the previous two paragraphs with respect to device 300, the processing circuitry 310 may be further configured to determine a multidimensional shape of the object based on the sensor data. Furthermore, in addition to or in combination with any of the features described in this or the previous paragraph, the multidimensional shape of the object may include a three-dimensional shape of the object. Furthermore, in addition to or in combination with any of the features described in this or the previous two paragraphs, the processing circuitry 310 may be further configured to determine a multidimensional shape of the hand based on the sensor data. Furthermore, in addition to or in combination with any of the features described in this or the previous two paragraphs, the multidimensional shape of the hand may include a three-dimensional shape of the hand. Furthermore, in addition to or in combination with any of the features described in this or the previous two paragraphs, processing circuitry 310 may be further configured to determine, based on the sensor data, a force applied to the object at the manipulation point, wherein the data label further may include the force. Furthermore, in addition to or in combination with any of the features described in this or the previous two paragraphs, the sensor data may be received from an image sensor 320 (e.g., a camera, a depth camera, etc.), a barcode scanner, a pressure sensor, and/or a force sensor (e.g., a glove worn on the hand).

Furthermore, in addition to or in combination with any of the features described in this or the previous three paragraphs with respect to device 300, the sensor data about the object may include an observation of a human interaction with the object according to a task, wherein the human interaction may include grasping the object with the hand. Furthermore, in addition to or in combination with any of the features described in this or the previous three paragraphs, the data label may further include a task associated with the observed grasping of the object, wherein the processing circuitry 310 may be configured to determine the grasping point for the item based on a comparison of the task to a planned task of the robot. Furthermore, in addition to or in combination with any of the features described in this or the previous three paragraphs, the processing circuitry 310 may be configured to segregate the object from the hand based on a depth image including depth information, wherein the sensor data may include the depth image captured by image sensor 320. Furthermore, in addition to or in combination with any of the features described in this or the previous three paragraphs, processing circuitry 310 may be configured to render a three-dimensional stick model of the hand based on the sensor data and to determine the observed grasping of the object by the hand based on the three-dimensional stick model. Furthermore, in addition to or in combination with any of the features described in this or the previous three paragraphs, sensor data about the object may include a series of images of the object (e.g., captured by image sensor 320) as it is being manipulated by the hand.

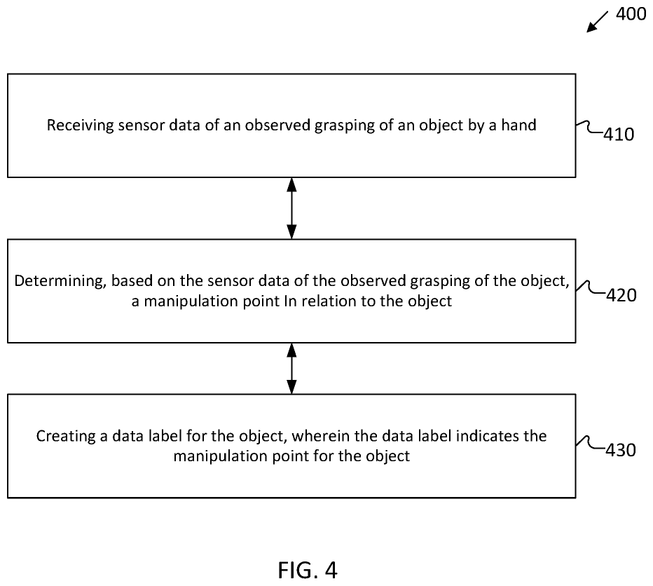

FIG. 4 depicts a schematic flow diagram of a method 400 for labeling images with grasp points and/or task-related information. The method 400 may include any of the features of the labeling systems discussed above (e.g., labeling system 100, device 300). Method 400 includes, in 410, receive sensor data of an observed grasping of an object by a hand. Method 400 also includes, in 420, determining, based on the sensor data of the observed grasping of the object, a (e.g., at least one) manipulation point in relation to (e.g., on) the object. Method 400 also includes, in 430, creating a data label for the object, wherein the data label indicates the manipulation point for the object.

In the following, various examples are provided that may include one or more aspects described above with reference to the labeling systems discussed above (e.g., labeling system 100, device 300, method 400, etc.). The examples provided in relation to the devices may apply also to the described method(s), and vice versa.

Example 1 is a device including processing circuitry coupled to storage, the processing circuitry is configured to receive sensor data of an object, an observed grasping of the object by a hand. The processing circuitry is also configured to determine, based on the sensor data of the observed grasping of the object, a (e.g., at least one) manipulation point in relation to (e.g., on) the object. The processing circuitry is also configured to create a data label for the object, wherein the data label indicates the manipulation point for the object.

Example 2 is the device of example 1, wherein the processing circuitry is further configured to control a robot to grasp an item at a grasping point based on the manipulation point in the data label.

Example 3 is the device of either of examples 1 or 2, wherein the processing circuitry is further configured to determine a grasping point for a robot to grasp an item based on the manipulation point in the data label.

Example 4 is the device of any of examples 1 to 3, wherein the processing circuitry is further configured to store the data label in a memory that associates data labels with object identifiers, wherein the data label and an identifier for the object include a record in a database of the memory.

Example 5 is the device of any of examples 1 to 4, wherein the processing circuitry is configured to identify the object based on a barcode label on the object that provides a unique identifier for the object.

Example 6 is the device of any of examples 1 to 5, wherein the processing circuitry is configured to determine the observed grasping of the object by the hand based on the sensor data, wherein the processing circuitry is further configured to segregate the hand from the object based on the sensor data and determine a pose of the hand with respect to the object.

Example 7 is the device of example 6, wherein the sensor data includes an image of the object and the hand, wherein the processing circuitry is configured to determine the pose of the hand based on an interference extraction on the image, a peak extraction from the image, and a rendering, based on the image, of a set of key points that define a multidimensional stick model of the pose.

Example 8 is the device of example 7, wherein the set of key points includes multiple points that together define the multidimensional stick model.

Example 9 is the device of example 8, wherein the multiple points include twenty-one points that together define the multidimensional stick model.

Example 10 is the device of any of examples 1 to 9, wherein the processing circuitry is further configured to determine a multidimensional shape of the object based on the sensor data.

Example 11 is the device of example 10, wherein the multidimensional shape of the object includes a three-dimensional shape of the object.

Example 12 is the device of any of examples 1 to 11, wherein the processing circuitry is further configured to determine a multidimensional shape of the hand based on the sensor data.

Example 13 is the device of example 12, wherein the multidimensional shape of the hand includes a three-dimensional shape of the hand.

Example 14 is the device of any of examples 1 to 13, wherein the processing circuitry is further configured to determine, based on the sensor data, a force applied to the object at the manipulation point, wherein the data label further includes the force.

Example 15 is the device of any of examples 1 to 14, wherein the sensor data is received from a camera, a depth camera, a barcode scanner, a pressure sensor, and/or a force sensor (e.g., a glove worn on the hand).

Example 16 is the device of any of examples 1 to 15, wherein the sensor data about the object includes an observation of a human interaction with the object according to a task, wherein the human interaction includes grasping the object with the hand.

Example 17 is the device of any of examples 1 to 16, wherein the data label further includes a task associated with the observed grasping of the object, wherein the processing circuitry is configured to determine the grasping point for the item based on a comparison of the task to a planned task of the robot.

Example 18 is the device of any of examples 1 to 17, wherein the processing circuitry is configured to segregate the object from the hand based on a depth image including depth information, wherein the sensor data includes the depth image.

Example 19 is the device of any of examples 1 to 18, wherein the processing circuitry is configured to render a three-dimensional stick model of the hand based on the sensor data and to determine the observed grasping of the object by the hand based on the three-dimensional stick model.

Example 20 is the device of any of examples 1 to 19, wherein the sensor data about the object includes a series of images of the object as it is being manipulated by the hand.

Example 21 is a robot including a sensor system configured to identify an object based on sensor data about the object. The robot also includes an end-effector for performing a task in relation to the object. The robot also includes a manipulation system configured to determine a grasping point by which the end-effector is to grasp the object when performing the task, wherein the grasping point is determined based on manipulation points for the task, wherein the manipulation points have been determined based on a learning model that associates objects with their manipulation points.

Example 22 is the robot of either of examples 21 or 21, wherein the sensor system includes a depth camera configured to capture a depth image (e.g., from an RGB depth camera) of the object.

Example 23 is the robot of any of examples 21 to 22, wherein the manipulation system is further configured to control the robot to grasp the object at the grasping point based on the manipulation points for the task.

Example 24 is the robot of any of examples 21 to 23, wherein the manipulation system is further configured to determine the grasping point based on comparing, via the learning model, the object to the objects associated with the manipulation points.

Example 25 is the robot of any of examples 21 to 24, the robot further including a memory to store the learning model.

Example 26 is the robot of any of examples 21 to 25, wherein the sensor system is configured to identify the object based on an image recognition of the object, wherein the manipulation system is configured to determine the grasping point based on locating the manipulation points of the object for the task.

Example 27 is the robot of any of examples 21 to 26, wherein the learning model is based on observations of a human interaction with the object according to a task, wherein the human interaction includes grasping the object with the hand.

Example 28 is the robot of any of examples 21 to 27, wherein the learning model includes images of the objects, each labelled with a manipulation point of the manipulation points.

Example 29 is a method including receiving sensor data of an observed grasping of an object by a hand. The method also includes determining, based on the sensor data of the observed grasping of the object, a (e.g., at least one) manipulation point in relation to (e.g., on) the object. The method also includes creating a data label for the object, wherein the data label indicates the manipulation point for the object.

Example 30 is the method of example 29, wherein the method further includes controlling a robot to grasp an item at a grasping point based on the manipulation point in the data label.

Example 31 is the method of either of examples 29 or 30, wherein the method further includes determining a grasping point for a robot to grasp an item based on the manipulation point in the data label.

Example 32 is the method of any of examples 29 to 31, wherein the method also includes storing (e.g., in a memory) the data label and associating the data label with an object identifier, wherein the data label and the object identifier include a record in a database.

Example 33 is the method of any of examples 29 to 32, wherein the method further includes identifying the object based on a barcode label on the object that provides a unique identifier for the object.

Example 34 is the method of any of examples 29 to 33, wherein the method further includes determining the observed grasping of the object by the hand based on the sensor data, wherein the method further includes segregating the hand from the object based on the sensor data and determine a pose of the hand with respect to the object.

Example 35 is the method of example 34, wherein the sensor data includes an image of the object and the hand, wherein the method further includes determining the pose of the hand based on an interference extraction on the image, a peak extraction from the image, and a rendering, based on the image, of a set of key points that define a multidimensional stick model of the pose.

Example 36 is the method of example 35, wherein the set of key points includes multiple points that together define the multidimensional stick model.

Example 37 is the method of example 36, wherein the multiple points include twenty-one points that together define the multidimensional stick model.

Example 38 is the method of any of examples 29 to 37, wherein the method further includes determining a multidimensional shape of the object based on the sensor data.

Example 39 is the method of any of examples 29 to 38, wherein the multidimensional shape of the object includes a three-dimensional shape of the object.

Example 40 is the method of any of examples 29 to 39, wherein the method further includes determining a multidimensional shape of the hand based on the sensor data.

Example 41 is the method of any of examples 29 to 40, wherein the multidimensional shape of the hand includes a three-dimensional shape of the hand.

Example 42 is the method of any of examples 29 to 41, wherein the method further includes determining, based on the sensor data, a force applied to the object at the manipulation point, wherein the data label further includes the force.

Example 43 is the method of any of examples 29 to 42, wherein the method further includes receiving the sensor data (e.g., wired or wirelessly) from a camera, a depth camera, a barcode scanner, a pressure sensor, and/or a force sensor (e.g., a glove worn on the hand).

Example 44 is the method of any of examples 29 to 43, wherein the sensor data about the object includes an observation of a human interaction with the object according to a task, wherein the human interaction includes grasping the object with the hand.

Example 45 is the method of any of examples 29 to 44, wherein the data label further includes a task associated with the observed grasping of the object, wherein the method further includes determining the grasping point for the item based on a comparison of the task to a planned task of the robot.

Example 46 is the method of any of examples 29 to 45, wherein the method further includes segregating the object from the hand based on a depth image including depth information, wherein the sensor data includes the depth image.

Example 47 is the method of any of examples 29 to 46, wherein the method further includes rendering a three-dimensional stick model of the hand based on the sensor data and determining the observed grasping of the object by the hand based on the three-dimensional stick model.

Example 48 is the method of any of examples 29 to 47, wherein the sensor data about the object includes a series of images of the object as it is being manipulated by the hand.

Example 49 is an apparatus including a means for receiving sensor data of an observed grasping of an object by a hand. The apparatus also includes a means for determining, based on the sensor data of the observed grasping of the object, a (e.g., at least one) manipulation point in relation to (e.g., on) the object. The apparatus also includes a means for creating a data label for the object, wherein the data label indicates the manipulation point for the object.

Example 50 is the apparatus of example 49, the apparatus further including a means for controlling a robot to grasp an item at a grasping point based on the manipulation point in the data label.

Example 51 is the apparatus of either of examples 49 or 50, the apparatus further including a means for determining a grasping point for a robot to grasp an item based on the manipulation point in the data label.

Example 52 is the apparatus of any of examples 49 to 51, the apparatus further including a means for storing the data label (e.g., in a memory) and associating the data label with an object identifier, wherein the data label and the object identifier include a record stored in a database.

Example 53 is the apparatus of any of examples 49 to 52, the apparatus further including a means for identifying the object based on a barcode label on the object that provides a unique identifier for the object.

Example 54 is the apparatus of any of examples 49 to 53, the apparatus including a means for determining the observed grasping of the object by the hand based on the sensor data, wherein apparatus further includes a means for segregating the hand from the object based on the sensor data and a means for determining a pose of the hand with respect to the object.

Example 55 is the apparatus of example 54, wherein the sensor data includes an image of the object and the hand, wherein the apparatus further includes a means for determining the pose of the hand based on an interference extraction on the image, a peak extraction from the image, and a rendering, based on the image, of a set of key points that define a multidimensional stick model of the pose.

Example 56 is the apparatus of example 55, wherein the set of key points includes multiple points that together define the multidimensional stick model.

Example 57 is the apparatus of example 56, wherein the multiple points include twenty-one points that together define the multidimensional stick model.

Example 58 is the apparatus of any of examples 49 to 57, the apparatus further including determining a multidimensional shape of the object based on the sensor data.

Example 59 is the apparatus of any of examples 49 to 58, wherein the multidimensional shape of the object includes a three-dimensional shape of the object.

Example 60 is the apparatus of any of examples 49 to 59, the apparatus further including determining a multidimensional shape of the hand based on the sensor data.

Example 61 is the apparatus of any of examples 49 to 60, wherein the multidimensional shape of the hand includes a three-dimensional shape of the hand.

Example 62 is the apparatus of any of examples 49 to 61, the apparatus further including determining, based on the sensor data, a force applied to the object at the manipulation point, wherein the data label further includes the force.

Example 63 is the apparatus of any of examples 49 to 62, wherein the sensor data is received from a camera, a depth camera, a barcode scanner, a pressure sensor, and/or a force sensor (e.g., a glove worn on the hand).

Example 64 is the apparatus of any of examples 49 to 63, wherein the sensor data about the object includes an observation of a human interaction with the object according to a task, wherein the human interaction includes grasping the object with the hand.

Example 65 is the apparatus of any of examples 49 to 64, wherein the data label further includes a task associated with the observed grasping of the object, wherein the apparatus further includes a means for determining the grasping point for the item based on a comparison of the task to a planned task of the robot.

Example 66 is the apparatus of any of examples 49 to 65, the apparatus further including a means for segregating the object from the hand based on a depth image including depth information, wherein the sensor data includes the depth image.

Example 67 is the apparatus of any of examples 49 to 66, the apparatus further including a means for rendering a three-dimensional stick model of the hand based on the sensor data and to determine the observed grasping of the object by the hand based on the three-dimensional stick model.

Example 68 is the apparatus of any of examples 49 to 67, wherein the sensor data about the object includes a series of images of the object as it is being manipulated by the hand.

Example 69 is a robot including means for identifying an object based on sensor data about the object. The robot also includes a means for performing a task in relation to the object. The robot also includes a means for determining a grasping point by which the robot is to grasp the object when performing the task, wherein the grasping point is determined based on a learning model that associates objects with manipulation points for the task.

Example 70 is the robot of either of examples 69 or 69, the robot further including a means for sensing the sensor data about the object (e.g., wherein the means for sensing includes a depth camera configured to capture a depth image of the object).

Example 71 is the robot of any of examples 69 to 70, the robot further including a means for controlling the robot to grasp the object at the grasping point based on the manipulation points for the task.

Example 72 is the robot of any of examples 69 to 71, wherein the robot further includes a means for determining the grasping point based on comparing, via the learning model, the object to the objects associated with the manipulation points.

Example 73 is the robot of any of examples 69 to 72, wherein the robot further includes a means for storing the learning model (e.g., in a memory).

Example 74 is the robot of any of examples 69 to 73, wherein the robot further includes a means for identifying the object based on an image recognition of the object and a means for determining the grasping point based on locating the manipulation points of the object for the task.

Example 75 is the robot of any of examples 69 to 74, wherein the learning model is based on observations of a human interaction with the object according to a task, wherein the human interaction includes grasping the object with the hand.

Example 76 is the robot of any of examples 69 to 75, wherein the learning model includes images of the objects, each labelled with a manipulation point of the manipulation points.

Example 77 is a non-transitory, computer-readable medium including instructions that, when executed, cause one or more processors to receive sensor data of an observed grasping of an object by a hand. The instructions also cause the one or more processors to determine, based on the sensor data of the observed grasping of the object, a (e.g., at least one) manipulation point in relation to (e.g., on) the object. The instructions also cause the one or more processors to create a data label for the object, wherein the data label indicates the manipulation point for the object.

Example 78 is the non-transitory, computer-readable medium of example 77, wherein the instructions further cause the one or more processors to control a robot to grasp an item at a grasping point based on the manipulation point in the data label.

Example 79 is the non-transitory, computer-readable medium of either of examples 77 or 78, wherein the instructions further cause the one or more processors to determine a grasping point for a robot to grasp an item based on the manipulation point in the data label.

Example 80 is the non-transitory, computer-readable medium of any of examples 77 to 79, wherein the instructions further cause the one or more processors to store the data label in a memory that associates data labels with object identifiers, wherein the data label and an identifier for the object include a record in a database of the memory.

Example 81 is the non-transitory, computer-readable medium of any of examples 77 to 80, wherein the instructions further cause the one or more processors to identify the object based on a barcode label on the object that provides a unique identifier for the object.

Example 82 is the non-transitory, computer-readable medium of any of examples 77 to 81, wherein the instructions further cause the one or more processors to determine the observed grasping of the object by the hand based on the sensor data, wherein the instructions further cause the one or more processors to segregate the hand from the object based on the sensor data and determine a pose of the hand with respect to the object.

Example 83 is the non-transitory, computer-readable medium of example 82, wherein the sensor data includes an image of the object and the hand, wherein the instructions further cause the one or more processors to determine the pose of the hand based on an interference extraction on the image, a peak extraction from the image, and a rendering, based on the image, of a set of key points that define a multidimensional stick model of the pose.

Example 84 is the non-transitory, computer-readable medium of example 83, wherein the set of key points includes multiple points that together define the multidimensional stick model.

Example 85 is the non-transitory, computer-readable medium of example 84, wherein the multiple points include twenty-one points that together define the multidimensional stick model.

Example 86 is the non-transitory, computer-readable medium of any of examples 77 to 85, wherein the instructions further cause the one or more processors to determine a multidimensional shape of the object based on the sensor data.

Example 87 is the non-transitory, computer-readable medium of any of examples 77 to 86, wherein the multidimensional shape of the object includes a three-dimensional shape of the object.

Example 88 is the non-transitory, computer-readable medium of any of examples 77 to 87, wherein the instructions further cause the one or more processors to determine a multidimensional shape of the hand based on the sensor data.

Example 89 is the non-transitory, computer-readable medium of any of examples 77 to 88, wherein the multidimensional shape of the hand includes a three-dimensional shape of the hand.

Example 90 is the non-transitory, computer-readable medium of any of examples 77 to 89, wherein the instructions further cause the one or more processors to determine, based on the sensor data, a force applied to the object at the manipulation point, wherein the data label further includes the force.

Example 91 is the non-transitory, computer-readable medium of any of examples 77 to 90, wherein the sensor data is received from a camera, a depth camera, a barcode scanner, a pressure sensor, and/or a force sensor (e.g., a glove worn on the hand).

Example 92 is the non-transitory, computer-readable medium of any of examples 77 to 91, wherein the sensor data about the object includes an observation of a human interaction with the object according to a task, wherein the human interaction includes grasping the object with the hand.

Example 93 is the non-transitory, computer-readable medium of any of examples 77 to 92, wherein the data label further includes a task associated with the observed grasping of the object, wherein the instructions further cause the one or more processors to determine the grasping point for the item based on a comparison of the task to a planned task of the robot.

Example 94 is the non-transitory, computer-readable medium of any of examples 77 to 93, wherein the instructions further cause the one or more processors to segregate the object from the hand based on a depth image including depth information, wherein the sensor data includes the depth image.

Example 95 is the non-transitory, computer-readable medium of any of examples 77 to 94, wherein the instructions further cause the one or more processors to render a three-dimensional stick model of the hand based on the sensor data and to determine the observed grasping of the object by the hand based on the three-dimensional stick model.

Example 96 is the non-transitory, computer-readable medium of any of examples 77 to 95, wherein the sensor data about the object includes a series of images of the object as it is being manipulated by the hand.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

1. A device comprising processing circuitry coupled to storage, the processing circuitry configured to:
receive sensor data of an observed grasping of an object by a hand;
determine, based on the sensor data of the observed grasping of the object, at least one manipulation point in relation to the object; and
create a data label for the object, wherein the data label indicates the at least one manipulation point for the object.

2. The device of claim 1, wherein the processing circuitry is further configured to control a robot to grasp an item at a grasping point based on the at least one manipulation point in the data label.

3. The device of claim 1, wherein the processing circuitry is further configured to determine a grasping point for a robot to grasp an item based on the at least one manipulation point in the data label.

4. The device of claim 3, wherein the data label further comprises a task associated with the observed grasping of the object, wherein the processing circuitry is configured to determine the grasping point for the item based on a comparison of the task to a planned task of the robot.

5. The device of claim 1, wherein the processing circuitry is further configured to store the data label in a memory that associates data labels with object identifiers, wherein the data label and an identifier for the object comprise a record in a database of the memory.

6. The device of claim 1, wherein the processing circuitry is configured to identify the object based on a barcode label on the object that provides a unique identifier for the object.

7. The device of claim 1, wherein the processing circuitry is configured to determine the observed grasping of the object by the hand based on the sensor data, wherein the processing circuitry is further configured to segregate the hand from the object based on the sensor data and determine a pose of the hand with respect to the object.

8. The device of claim 7, wherein the sensor data comprises an image of the object and the hand, wherein the processing circuitry is configured to determine the pose of the hand based on an interference extraction on the image, a peak extraction from the image, and a rendering, based on the image, of a set of key points that define a multidimensional stick model of the pose.

9. The device of claim 8, wherein the set of key points comprises multiple points that together define the multidimensional stick model.

10. The device of claim 1, wherein the processing circuitry is further configured to determine a multidimensional shape of the object based on the sensor data.

11. The device of claim 10, wherein the multidimensional shape of the object comprises a three-dimensional shape of the object.

12. The device of claim 1, wherein the processing circuitry is further configured to determine, based on the sensor data, a force applied to the object at the at least one manipulation point, wherein the data label further comprises the force.

13. The device of claim 1, wherein the sensor data is received from a camera, a depth camera, a barcode scanner, a pressure sensor, and/or a force sensor.

14. The device of claim 1, wherein the sensor data about the object comprises an observation of a human interaction with the object according to a task, wherein the human interaction comprises grasping the object with the hand.

15. The device of claim 1, wherein the processing circuitry is configured to segregate the object from the hand based on a depth image comprising depth information, wherein the sensor data comprises the depth image.

16. A non-transitory, computer-readable medium comprising instructions that, when executed, cause one or more processors to:
receive sensor data of an observed grasping of an object by a hand;
determine, based on the sensor data of the observed grasping of the object, at least one manipulation point in relation to the object;
create a data label for the object, wherein the data label indicates the at least one manipulation point for the object; and
control a robot to grasp an item at a grasping point based on the at least one manipulation point in the data label.

17. The non-transitory, computer-readable medium of claim 16, wherein the instructions further cause the one or more processors to render a three-dimensional stick model of the hand based on the sensor data and to determine the observed grasping of the object by the hand based on the three-dimensional stick model.

18. The non-transitory, computer-readable medium of claim 16, wherein the sensor data about the object comprises a series of images of the object as it is being manipulated by the hand.

19. A robot comprising:
a sensor system configured identify an object based on sensor data about the object;
an end-effector for performing a task in relation to the object; and
a manipulation system configured to determine a grasping point by which the end-effector is to grasp the object when performing the task, wherein the grasping point is determined based on manipulation points for the task, wherein the manipulation points have been determined based on a learning model that associates objects with their manipulation points.

20. The robot of claim 19, wherein the manipulation system is further configured to control the robot to grasp the object at the grasping point based on the manipulation points for the task.
